(19) United States
(12) Patent Application Publication
(10) Pub. No.: US 2006/0273573 A1
(43) Pub. Date: Dec. 7, 2006

(54) Easel pad with adhesive-containing patch

(76) Inventor: Larry E. Wittmeyer JR., Lake Lotawana, MO (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 11/145,686

(22) Filed: Jun. 6, 2005

(51) Int. Cl. B42D 3/00

(52) U.S. Cl. 281/33

(57) ABSTRACT

An easel pad having an adhesive-containing patch for removably adhering an instrument, such as a marker, to the easel pad.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

The present invention is directed to an easel pad, and more particularly to an easel pad having an adhesive-containing patch adapted to hold writing instruments, such as markers or separate smaller note pads, and other devices commonly used with easel pads.

### DESCRIPTION OF RELATED ART

Easel pads typically include a multiplicity of large aligned flexible sheets (i.e., typically paper sheets) in a stack which are attached together along an edge or margin of the sheets. Easel pads are large in size and usually include a stiff cover or back card upon which the stack of sheets is mounted. See generally U.S. Pat. No. 5,299,833 and U.S. Design Pat. No. 329,872, which are incorporated by reference.

Easel pads are used in a variety of ways. For example, easel pads are sometimes used as drawing pads for budding artists. In the commercial setting, easel pads are often used during meetings to record lists of items or ideas generated during the meeting. Suitable writing instruments, such as markers, are usually used to write on the sheets of the easel pad.

During use, easel pads are sometimes placed on an easel stand. The easel stand may include a stand ledge upon which the easel pad rests. This stand ledge is also useful for supporting markers, other writing instruments, block erasers, and the like. Other easel stands also have separate storage clips attached thereto for holding markers and other accessories.

Many easel pads are not used in conjunction with an easel stand, such as those easel pads that are hung on a wall, and therefore, an easel stand ledge is not available to the user. In addition, the use of the separate clips and the like to hold markers are often awkward because the clips must typically be manually opened with one hand before the writing instrument can be inserted or removed with the other hand. Accordingly, there remains a need to provide an easel pad which itself is adapted to easily hold markers and other instruments commonly used with easel pads.

### BRIEF SUMMARY OF THE INVENTION

An object of the present invention is to provide an easel pad which is adapted to removably hold three-dimensional objects, such as markers and other instruments commonly used with easel pads when the instrument is not being used by the user.

Another object of the present invention is to provide an easel pad which permits the user to easily remove the three dimensional object, such as the marker or other writing instrument, from the easel pad.

A further object of the present invention is to provide an easel pad having an adhesive-containing patch which conforms to the surface of the three-dimensional object, such as the marker or writing instrument adhered to the patch.

Other objects and advantages of the present invention will be apparent from the following description and accompanying drawings.

### BRIEF DESCRIPTION OF THE DRAWINGS

FIG. 1 is a plan view of an easel pad having an adhesive-containing patch in accordance with a first embodiment of the present invention.

FIG. 2 is a perspective view of a portion of the easel pad shown in FIG. 1, illustrating a writing instrument removably adhered to the adhesive-containing patch.

FIG. 2A is a cross-sectional view of the easel pad shown in FIG. 2 taken along lines 2A-2A.

FIG. 3 is a plan view of an easel pad having an adhesive-containing patch in accordance with a second embodiment of the present invention.

FIG. 3A is a cross-sectional view of the easel pad shown in FIG. 3 taken along line 3A-3A, showing a writing instrument removably adhered to the adhesive patch.

### DETAILED DESCRIPTION OF THE PREFERRED EMBODIMENTS

Turning now to the drawings, various easel pads 10 in accordance with the present invention are shown. In general, the easel pad 10 is comprised of a stack of flexible sheets 20, preferably paper, positioned in a first major plane of the easel pad and bound to one another along an edge or margin 22, usually the top margin of the pad, to hold the sheets 20 together in a pad-type arrangement. Staples, fasteners, adhesive (hot melt, fugitive, repositional, etc.) or other suitable pad binding methods are conventionally provided to secure the sheets to one another along the margin 22.

In the preferred embodiment, repositional adhesive is applied along the back sides of the sheets to bind the sheets together. Numerous products using repositionable sensitive adhesive are commercially available, as are the adhesive compositions themselves. The repositionable adhesive is preferably a repositionable microsphere pressure-sensitive adhesive. The adhesive is generally applied in the form of a strip adjacent to the bound margin of the sheet, so that the individual sheets may be removed from the easel pad and adhered to another supporting surface, such as a wall. To facilitate the removal of each sheet from the pad, a separation or perforation line (not shown) optionally extends across each sheet between the binding and repositional adhesive. In addition, a release strip (not shown) may be provided over the adhesive on the sheets. The release strip may comprise a separate strip of release material or a folded portion of the sheet.

The sheets 20 of the easel pad may be any suitable shape or size, but are preferably rectangular or square in shape. Typically, the sheets range in size from about 1.5 to three feet wide by about two to four feet high, and are more preferably about two feet wide by about three feet high.

The sheets 20 of the present invention are made of any suitable substrate. The sheet material is preferably comprised of paper, vellum, or plastic film materials, such as polyethylene, polypropylene and polyester, including MYLAR® available from Dupont. Most preferably, the flexible sheet material is comprised of paper. Also, as is known in the art, the flexible sheet material may include various coatings, such as a primer coating or release coating.

The easel pad 10 of the present invention preferably includes a cover 30 comprised of relatively stiff material, such as those cover materials conventionally used in easel pads. Typically, the cover material is such that it can be repeatedly bent and folded without fracturing. Examples of suitable cover materials include heavy gauge paper, cardboard, polyethylene, polypropylene, vinyl, nylon, rubber, leather, various impregnated or laminated fibrous materials, various plasticized materials, and the like, and combinations of such materials (e.g., cardboard with a plastic lamination).

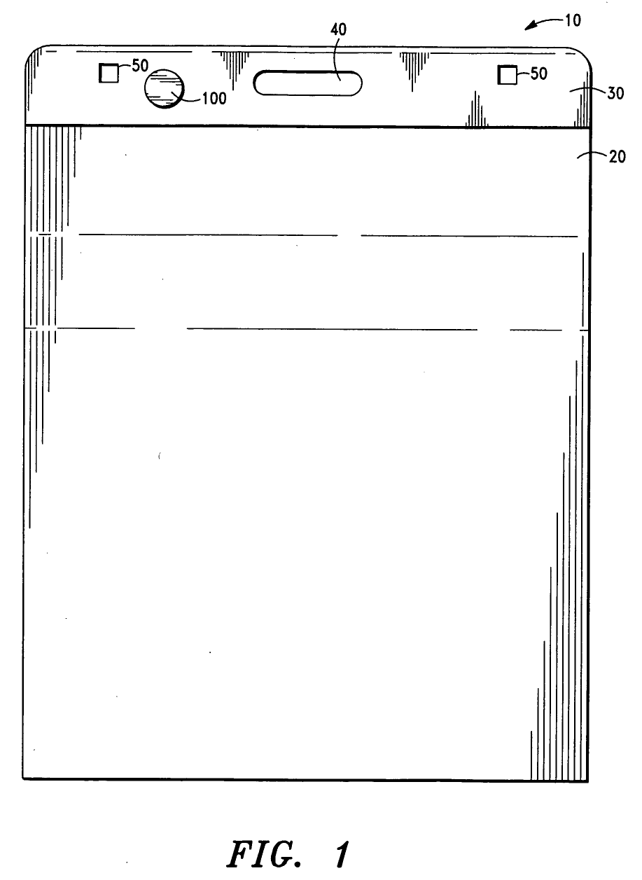

Any suitable cover 30 design may be used. In most instances, it is desirable to construct the cover 30 of the easel pad with a bottom cover panel 32 that extends along the length of the bottommost sheet in the stack of flexible sheets 20 as generally illustrated in FIG. 1. The bottom cover panel 32 provides stiff support for the flexible sheets 20, which facilitates the positioning of the easel pad 10 on an easel stand. In addition, the bottom cover panel 32 provides a more stable and level sheet writing surface during use. A front cover panel 34 may be formed by folding a unitary piece of cover material along a fold-line and then securing the stack of sheets between the “v”-shaped portion defined by the bottom cover panel 32 and front cover panel 34. The bottom cover panel 32 and front cover panel 34 may alternatively be formed of separate pieces of cover material which are adhered together at a margin using conventional binding means.

As discussed more fully below, in accordance with the present invention, the easel pad 10 comprises an adhesive-containing patch 100 used to removably secure a three-dimensional object, such as a writing instrument or separate smaller note pad, to the pad. A portion of the patch 100 is affixed (preferably permanently) to the cover 30 and/or the sheets 20 of the easel pad using any suitable attachment means, such as staples, glue, velcro, stitching, and the like. Another portion of the-containing patch 100 contains adhesive 120 which is used to removably secure a three dimensional object 80, such as a marker or other writing instrument, to the easel pad 10.

The pliability and thickness of the adhesive-containing patch 100 is preferably such that it conforms to a portion of the surface of the three-dimensional object. For example, when a cylindrical object such as a marker is placed against the patch to removably secure the object to the patch, the patch deforms such that the patch at least partially conforms to the three-dimensional contour of the cylinder. This increases the overall contact surface area between the patch and the cylinder in contrast to a thin hard patch that would only contact the cylinder in a relatively tangential manner.

The thickness of the adhesive-containing patch 100 typically ranges between about 0.004 to about 0.5 inches, more preferably between about 0.01 to about 0.3 inches, and most preferably between about 0.06 to 0.12 inches thick.

The adhesive-containing patch 100 may be any suitable size and shape (e.g., rectangular, circular, triangular, elliptical, oblong, and the like). The patch 100 may be continuous, (e.g., a solid continuous circular patch) or discontinuous (e.g., a series of strips or a plurality of small dots). Typically, the adhesive-containing patch 100 is dimensioned to provide a contact area between about 0.25 to 12 square inches, more preferably between about 0.5 and 6 square inches, and most preferably about 1 to 4 square inches. Exemplary patches are circular in shape and have a radius between about 0.5 to 12 inches, more preferably between about 1 and 6 inches, and most preferably about 2 to 4 inches.

In one aspect, the adhesive-containing patch 100 comprises a substrate 110 having a first major surface 112 and a second major surface 114, with adhesive 120 on at least a portion of the second major surface 114, and preferably on both surfaces 112, 114. Although the tackiness of adhesive may be substantially the same on both surfaces, it is preferable that the adhesive used on the first major surface 112 (i.e., the surface to be applied to the easel pad cover and/or easel pad sheets) have a higher degree of tack than the adhesive used on the second major surface 114 (i.e., the surface adapted to contact and hold the writing instrument or separate smaller pad such as a POST-IT® note product). Most preferably, the adhesive on the first major surface comprises a permanent adhesive while the adhesive on the second major surface comprises a removable adhesive, such as a pressure sensitive adhesive.

Suitable materials for forming the substrate 110 of the adhesive-containing patch 100 include foam, urethane, vinyl, polyethylene, acrylic, neoprene, felt, clay, wax, various other elastomeric polymers and other similar material.

Suitable materials for forming the adhesive-containing patch 100 are commercially available. Examples include double-coated removable foam tape with adhesive (e.g., Product No. 4658F commercially available from 3M), double-coated elastomeric tape (e.g., Product No. 4921 from 3M), double-coated polyethylene foam tapes (e.g., Product Nos. 4462W, 4462B, 4466W, 4466B, 4492G, 4492W, 4492B, 4496G, 4496W, 4496B, from 3M), double-coated urethane foam tapes (e.g., Product Nos. 4004, 4008, 4016, 4026, 4032, 4052, 4056, and 4085 from 3M), and double-coated vinyl foam tapes (e.g., Product Nos. 4432, 4416, 4408 from 3M). Such tapes may sometimes include a backing or release sheet covering the adhesive. The adhesive-containing patch 100 is formed from such tapes by cutting with scissors or other conventional cutting devices to the desired size and shape. The adhesive-containing patch 100 is then permanently secured to the easel pad, and the optional backing or release sheet is removed.

In another aspect of the present invention, the adhesive-containing patch consists essentially of adhesive itself. That is, a suitable adhesive is thus applied directly to the easel pad. The adhesive contains sufficient tack to adhere to the easel pad. In addition, the adhesive is sufficiently tacky so that the adhesive-containing patch enables the writer or drawer to quickly and easily obtain the instrument from the pad, and deposit the instrument back on the easel pad when the writer or drawer is finished using the instrument. It is also preferable that the patch of adhesive be sufficiently thick and pliable such that the patch conforms to the contour of a three-dimensional object, such as a marker, placed thereon.

Various hot-melt adhesives which retain their tackiness at room temperature are commercially available. Suitable adhesives are also described in U.S. Pat. No. 3,309,052 and U.S. Pat. No. 3,165,382, which are incorporated by reference.

While several embodiments are discussed below, those skilled in the art will readily appreciate that various modifications may be made, and the invention is not limited to the specific forms or arrangement of parts and steps described herein.

### First Embodiment

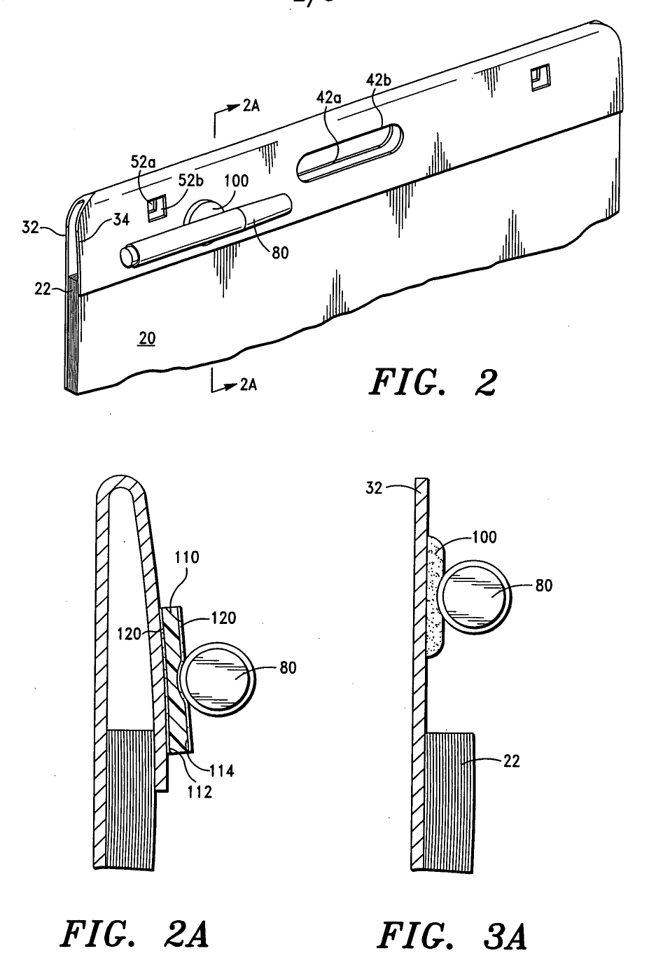

FIGS. 1, 2, and 2A illustrate an easel pad 10 in accordance with a first embodiment of the present invention. The easel pad 10 comprises a stack of flexible sheets 20 and a cover 30 having both a bottom cover panel 32 and a front cover panel 34. In addition, the cover 30 includes a handle 40 made of a pair of complementary handle openings 42a, 42b comprised of elongated holes, as well as two lateral hanging openings 50, each hanging opening 50 comprised of a pair of complementary holes 52a, 52b adapted to receive hanging pegs or hooks.

The easel pad includes an adhesive-containing patch 100 applied to the front cover panel 34. In this embodiment, the adhesive-containing patch is a substantially circular patch of double-coated removable felt substrate with adhesive. Such materials for forming the patch are commercially available under the product name “Gripping Stuff for Posters” (Gripping Stuff International, UK) at gripping-stuff.com. The patch comprises a foam substrate 110 having adhesive 120 on both major surfaces 112, 114 of the substrate 110. The circular patch has a diameter of about 2.5 inches, and a thickness of about 0.06 to 0.12 inches. The adhesive 120 on the first major surface 112 adheres the patch to the cover of the easel pad. The adhesive 120 on the second major surface 114 is used to removably secure a three-dimensional object 80 to the easel pad.

As illustrated in FIGS. 2 and 2A, when a writing instrument is placed on the adhesive-containing patch 100, the adhesive on the outer major surface of the adhesive-containing patch is sufficiently tacky to removably adhere the writing instrument to the easel pad. In addition, as shown in FIG. 2A, the adhesive-containing patch conforms to the contour of the writing instrument, which increases the contact surface area between the adhesive of the adhesive-containing patch and the writing instrument.

### Second Embodiment

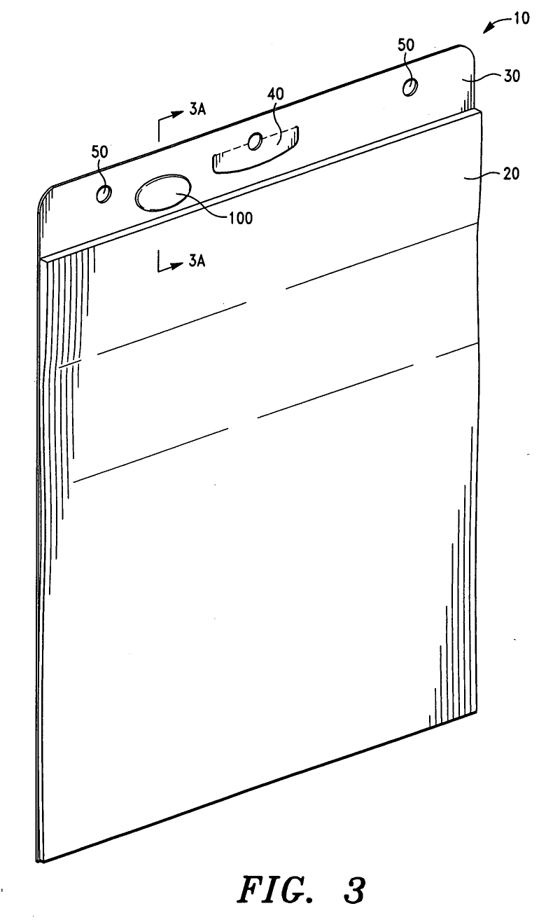

FIGS. 3 and 3A illustrate an easel pad 10 in accordance with a second embodiment of the present invention. The easel pad 10 comprises a stack of flexible sheets 20, a cover 30 comprising a bottom cover panel 32, and a handle 40 comprised of a foldable flap in the bottom cover panel 32. In addition, the cover 30 includes two lateral hanging openings 50 adapted to receive hanging pegs or hooks.

The easel pad includes an adhesive-containing patch 100 applied to the bottom cover panel 32. In this embodiment, the adhesive-containing patch comprises a patch of hot-melt adhesive which retains its tackiness at room temperature. An example of suitable adhesive for forming the patch is Product No. 1769 and commercially available from Adhesive Compounders (Des Moines, Iowa). The patch has a diameter of about 2.5 inches, and a thickness of about 0.06 to 0.12 inches.

As illustrated in FIG. 3A, when a writing instrument is placed on the adhesive-containing patch 100, the tackiness of the adhesive in the adhesive-containing patch is sufficient to removably adhere the writing instrument to the easel pad. In addition, as shown in FIG. 3A, the adhesive-containing patch conforms to the contour of the writing instrument, which increases the contact surface area.

While specific embodiments have been shown and discussed, various modifications may of course be made, and the invention is not limited to the specific forms or arrangement of parts and steps described herein, except insofar as such limitations are included in the following claims. For example, in view of this disclosure, it will be readily apparent to one skilled in the art that the adhesive-containing patch could be applied to any suitable location on the pad, including the edge of the stack of flexible sheets. Further, it will be understood that certain features and sub-combinations are of utility and may be employed without reference to other features and sub-combinations. This is contemplated by and is within the scope of the claims.

What is claimed and desired to be secured by Letters Patent is as follows:

1. An easel pad comprising:
a stack of flexible sheets positioned in a first major plane of said easel pad;
an optional cover attached to said stack of flexible sheets;
an adhesive-containing patch attached to said stack of flexible sheets or said optional cover, said adhesive-containing patch adapted to removably secure a three-dimensional object to said patch.

2. The easel pad of claim 1 wherein said cover comprises a bottom cover panel and a front cover panel, and wherein said adhesive-containing patch is attached to either said bottom cover panel or said front cover panel.

3. The easel pad of claim 1 wherein said adhesive-containing patch comprises a substrate having adhesive on a first major surface of said substrate, said adhesive on said first major surface adapted to removably secure a three-dimensional object to said patch.

4. The easel pad of claim 1, wherein said adhesive-containing patch is a composite material selected from the group consisting of double-coated removable foam tape with adhesive, double-coated elastomeric tape with adhesive, double-coated polyethylene foam tape with adhesive, double-coated urethane foam tape with adhesive, and double-coated vinyl foam tape with adhesive.

5. The ease pad of claim 1 where said adhesive-containing patch is comprised of a hot-melt adhesive which retains its tackiness at room temperature.

6. The easel pad of claim 1 wherein said three-dimensional object is a writing instrument that is removably secured to said adhesive-containing patch.

7. The easel pad of claim 6 wherein said adhesive-containing patch has a first major surface and a second major surface, said first major surface attached to said stack of flexible sheets or said optional cover and said second major surface adapted to conformationally and removably secure said writing instrument to said patch.

8. The easel pad of claim 1 wherein said stack of flexible sheets has an edge, and wherein said adhesive-containing patch is applied to said edge.

9. A method for holding at least one three-dimensional object to an easel pad comprising:
providing an easel pad comprising
a stack of flexible sheets positioned in a first major plane; and
an optional cover attached to said stack of flexible sheets;
securing an adhesive-containing patch to said easel pad; and
removably securing said three-dimensional object on said adhesive-containing patch.

10. The method for holding at least one three-dimensional object on an easel pad of claim 9 wherein said adhesive-containing patch is secured to a bottom cover panel of said optional cover.

11. The method for holding at least one three-dimensional object on the easel pad of claim 9 wherein said adhesive-containing patch comprises a substrate having adhesive on a first major surface of said substrate, said adhesive on said first major surface adapted to removably secure said three-dimensional object to said patch.

12. The method for holding at least one three-dimensional object on the easel pad of claim 9 wherein said adhesive-containing patch is a composite material selected from the group consisting of double-coated removable foam tape with adhesive, double-coated elastomeric tape with adhesive, double-coated polyethylene foam tape with adhesive, double-coated urethane foam tape with adhesive, and double-coated vinyl foam tape with adhesive.

13. The method for holding at least one three-dimensional object on the easel pad of claim 9 wherein said adhesive-containing patch is comprised of a hot-melt adhesive which retains its tackiness at room temperature.

14. The method for holding at least one three-dimensional object on the easel pad of claim 9 wherein adhesive-containing patch is pliable and conforms to the contour of said three-dimensional object.

15. The method for holding at least one three-dimensional object on the easel pad of claim 9 wherein said adhesive-containing patch is secured to an edge of said stack of flexible sheets.

16. The method for holding at least one three-dimensional object on the easel pad of claim 9 wherein said three-dimensional object is a writing instrument.
